(19) United States
(12) Patent Application Publication
(10) Pub. No.: US 2024/0389773 A1
(43) Pub. Date: Nov. 28, 2024

(54) THREE DIMENSIONAL (3D) PRINTED PILLOW

(71) Applicant: Standard Fiber, LLC, Foster City, CA (US)

(72) Inventors: W. Alexander Gray, III, Whitefish, MT (US); Chun Leung Chan, Belmont, CA (US)

(21) Appl. No.: 18/664,868

(22) Filed: May 15, 2024

Related U.S. Application Data
(60) Provisional application No. 63/468,428, filed on May 23, 2023.

(51) Int. Cl. A47G 9/10; B33Y 80/00

(52) U.S. Cl. CPC A47G 9/1009; B33Y 80/00

(57) ABSTRACT

A pillow has a body having a top, a bottom, and a plurality of sides. At least a portion of the body is formed by a 3 dimensional (3D) printed matrix.

### CROSS-REFERENCE TO RELATED APPLICATION DATA

This application claims the benefit of and priority to Provisional U.S. Patent Application Ser. No. 63/468,428, filed May 23, 2023, titled, THREE DIMENSIONAL (3D) PRINTED PILLOW, the disclosure of which is incorporated herein in its entirety.

### BACKGROUND

The following description relates to a 3D printed pillow, and more particularly, to a pillow that is formed by a three dimensional (3D) printing process that permits various performance characteristics.

Different types of pillow have their fans. Some individuals prefer foam pillows, such as latex foam or memory foam pillows, which have a slow matching profile and likewise, a slow return or spring-back profile. These materials match the pressure applied to or against the foam material, but respond slowly to the applied pressure. Once the pressure is removed from the material, it slowly returns to its original shape.

Other individuals prefer fiber fill pillows. These materials provide consistent support or pressure against a compressive force. They do not have a delayed response in return or spring back, do not conform to the body part on the pillow and may not return to their original shape. Fiber fill pillow typically “sleep” cooler than memory foam pillows.

In addition to memory foam and fiber fill, other pillows may have down or feather fill, and still other pillows are hybrid, having a combination of fiber and foam, down/feather and foam, a combination of latex and fiber, fiber balls and the like. All of these pillows have one thing in common, they all have singular characteristics. That is a pillow cannot function or perform having multiple characteristics.

Accordingly, it is desirable to provide a dual performance pillow that performs similar to a pillow having a memory foam fill and also performs similar to a pillow having a non-memory foam fill, such as a fiber fill.

### SUMMARY

In one aspect, a pillow has a body having a top, a bottom, and a plurality of sides. At least a portion of the body is formed by a 3 dimensional (3D) printed matrix. The 3D printed matrix can be formed by a plurality of cells, each cell of the plurality of cells having a plurality of struts and nodes interconnecting the struts.

In embodiments, one or more regions of the pillow has a construction characteristic different from a construction characteristic of one or more other regions of the pillow. Examples of construction characteristics include the number of cells in the matrix, the volume of material in a given cell or cells, struts and/or nodes, and the type or shape of the cells that form the matrix.

In embodiments, one of the one or more regions is a central region. The central region can have a greater softness than the one or more other regions of the pillow, such as those regions surrounding the central region. In other embodiments, the region or regions are other than central of the pillow; that is the region or regions can be anywhere on the pillow.

The greater softness of the central region can be formed by the 3D matrix having one or more of a lesser density of cells forming the matrix, a lesser volume of material in at least some of the cells, a lesser amount or volume of material in the struts and/or nodes, and a different type or shape of the cells that form the central region.

In an embodiment, the entirety of the body is formed by the 3D printed matrix. In an embodiment, the top or a portion of the top is formed by the 3D matrix.

In embodiments, the plurality of sides are formed by gusset panels and one or more of the gusset panels are formed by the 3D matrix. Suitable materials to form the 3D printed matrix include thermoplastic elastomers (TPEs), thermoplastic polyurethane (TPU), thermoplastic co-polyester (TPC), polyurethane (PU) and polyurethane-like and based materials. Other suitable materials may include as polypropylene (PP) and polyamide (nylon). Combinations of all of these materials may also be used.

In embodiments, travel pillows, continuous positive airway pressure (CPAP) pillows, cervical pillows, pregnancy pillows, chiropractic pillows, or body pillows can be formed fully by 3D printing or partially by 3D printing. In any embodiment, one or more regions of the pillow can have construction characteristics different from construction characteristics of one or more other regions of the pillow, or the entirety of the pillow can have the same construction characteristics.

The pillows or portions of pillows can be 3D printed using a variety of printing methods such as vat polymerization, stereolithography, digital light processing and the like. Other suitable 3D printing methods will be recognized by those skilled in the art.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is a perspective view of an embodiment of a three dimensional (3D) printed pillow in accordance with the present disclosure, in which the entirety of the pillow is formed by 3D printing;

FIG. 2 is a perspective view of another embodiment of a 3D printed pillow in accordance with the present disclosure, in which a portion of the pillow is formed by 3D printing;

FIG. 3 is a perspective illustration of the pillow of FIG. 2 with a portion of a cover shown joined thereto;

FIG. 4 is a cross-sectional view taken along line 4-4 of FIG. 1;

FIG. 5 is a yet another perspective illustration of a pillow showing a lower density of cells in the encircled central region of the pillow;

FIG. 6 illustrates yet another embodiment of a pillow with an insert 3D printed member;

FIG. 7 illustrates still another embodiment of a pillow with 3D printed gussets;

FIG. 8 illustrates an example of a travel pillow formed from a 3D matrix in accordance with the present disclosure;

FIG. 9 illustrates an example of a continuous positive airway pressure (CPAP) pillow that is anticipated to be formed from a 3D matrix in accordance with the present disclosure; and

FIG. 10 illustrates an example of a cervical pillow that is anticipated to be formed from a 3D matrix in accordance with the present disclosure,

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

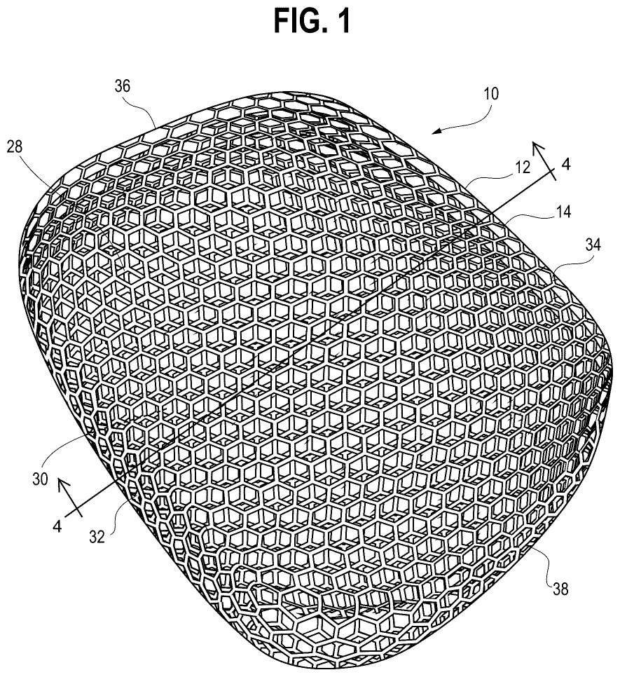

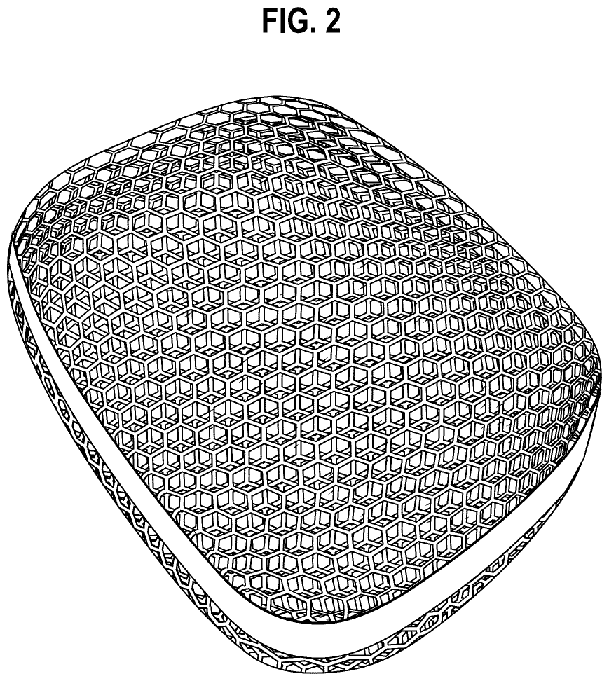

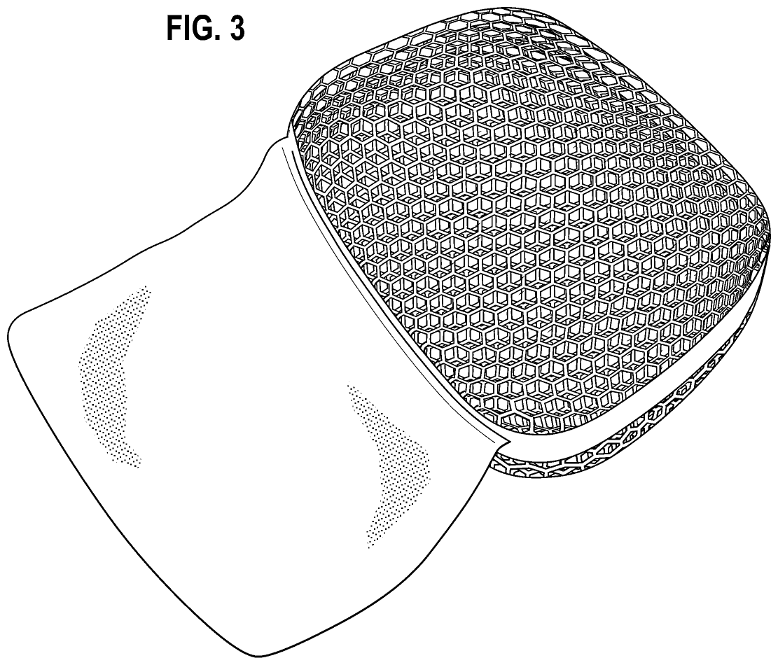

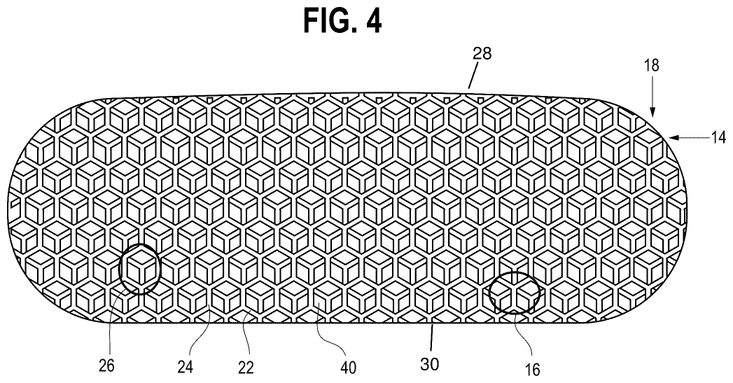

A three dimensional (3D) printed pillow 10 can have varying characteristics, such as softness and can provide multi-directional air flow for example for cooling. Referring to FIG. 1, a pillow 10 has a body 12 formed in a 3D printing process. As seen in FIGS. 1 and 4, the 10 pillow is formed from a material that is printed in a matrix 14, such as the illustrated hexagonal matrix. The matrix 14 can be formed by printing a series of hexagonal latices 16 that are interconnected by adjacent orthogonal hexagonal matrices 18, or by a series of straight printed connecting elements or in any other appropriate manner to interconnect the series of matrices 14, 18. It will also be appreciated from the present disclosure that the matrices 14, 18 need not be hexagonal, but can be in any appropriate or suitable geometric shape. Suitable materials to form the 3D printed pillow 10 include thermoplastic elastomers (TPEs), thermoplastic polyurethane (TPU), thermoplastic co-polyester (TPC), polyurethane (PU) and polyurethane-like and based materials. Other suitable materials may include as polypropylene (PP) and polyamide (nylon). Combinations of all of these materials may also be used.

For purposes of the present disclosure, reference will be made to strut elements or struts 22 which are straight elements and node elements or nodes 24 which are the connecting points between or among struts 22. Reference will also be made to cells 26, which are the individual shapes, such as the individual hexagonal shapes formed by the struts 22 and nodes 24, that form the matrices 14, 18.

The illustrated pillow 10, which is an example embodiment, is formed fully from the 3D printed matrices 14, 18. That is, referring briefly to FIGS. 1 and 4, the lattice 16 extends from a top 28 of the pillow 10 to a bottom 30 of the pillow 10, front 32 to back 34 and side 36 to side 38. The top 28, bottom 30, front 32, rear 34 and sides 36, 38 can be formed to be clearly distinguished panels or can be formed such that they continue into one another without a clear line or border distinguishing the various panels from each other.

In that the entirety of the illustrated pillow 10 is formed as a lattice 16, with open spaces 40 between each of the hexagonal (or other shaped elements), air can freely flow into, out of and through the pillow 10. Advantageously, such a configuration provides for a natural cooling effect by allowing and, when pressure is applied, perhaps forcing air flow thought the matrix lattice 16.

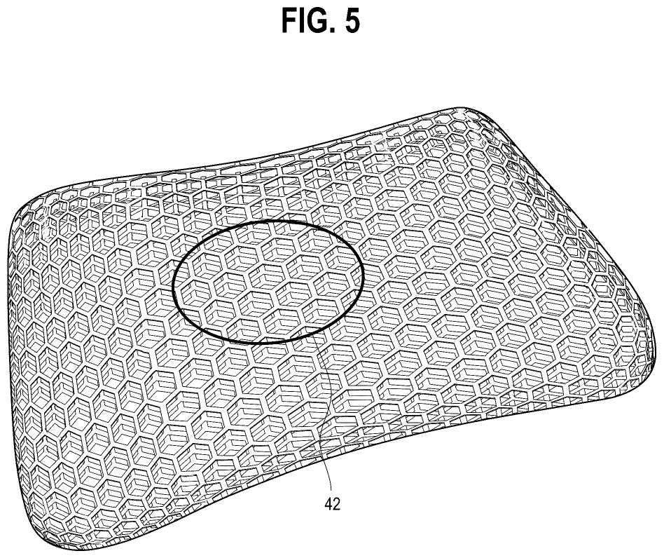

The pillow 10 can be formed having varying characteristics. For example, the pillow 10 can have different softness or firmness characteristics, and these characteristics can be made in different areas or zones of the pillow. For example, as illustrated in FIG. 5, the softness or firmness characteristics in one or more desired zones can be varied by altering the density of the matrix 14, 18, such as in the encircled area 42. That is, in a given area or zone (a zone being an area and a depth, defining a volume, as indicated at 42), the number of cells 26 can vary. For example, to create a softer pillow, the number of cells 26 can be increased or the cell 26 density decreased. This results in a softer area in the less dense cell 26 area 42. This can be, for example, where a user's head may rest on the pillow 10. Conversely, the firmness of the pillow 10 can be increased by increasing the cell 26 density in a desired area or volume, for example, in the user's neck area to provide additional neck support.

The softness or firmness characteristics can also be varied by varying the thickness of the struts 22 and nodes 24 in the matrix 14, 18. This can be accomplished by printing with a greater or lesser volume of material in a given member (struct 22 and/or node 24) to create a softer or firmer feel to the pillow 10 or the desired area of the pillow.

It is also contemplated that the softness or firmness characteristics of the pillow 10 can be varied by changing the type or shape of the cells 26 or lattice 16 structure that forms the matrix 14, 18 in a particular zone. For example, the cells 26 can be changed from hexagonal to cubic cells 26, again, to vary the softness or firmness characteristics of the pillow 10. It is further contemplated that all or a combination of varying the number of cells 26, varying the volume of material in a given member (i.e., strut 22 and/or node 24) and varying the type or shape of the cells 26 that form the matrix 14, 18 can accomplish varying the softness or firmness characteristics of the pillow 10.

It is also contemplated that varying these construction parameters (e.g., the number of cells 26, the volume of material in a given member 22, 24 and the type or shape of the cells 26 that form the matrix 14, 18) can also be employed to vary the air flow through the pillow 10 to obtain a desired air flow rate and/or pattern.

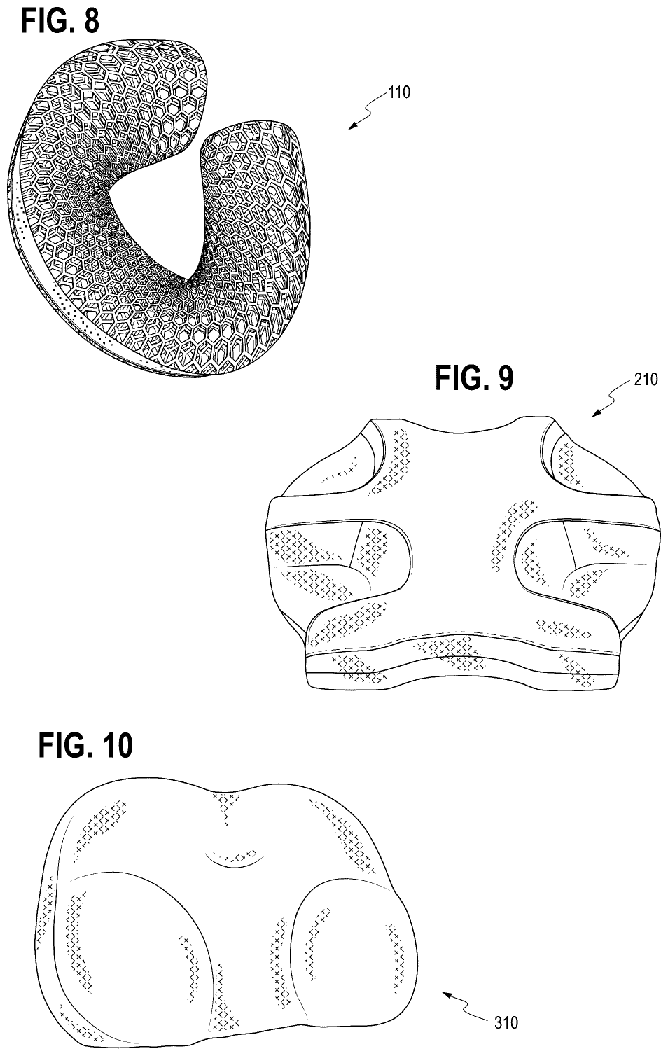

It will be appreciated that the present 3D printed pillow can be made in a variety of other shapes and to serve other purposes. For example, 3D printed pillows can be formed as a travel pillows 110 (FIG. 8), continuous positive airway pressure (CPAP) pillows 210 (FIG. 9), cervical pillows 310 (FIG. 10), pregnancy pillows (not shown), chiropractic pillows (not shown), body pillows (not shown) and the like, which pillows 10, 110, 210, 310 can have differing support characteristics at different zones of the pillow or can have the same support characteristics in all of the zones of the pillow or across the entirety of the pillow.

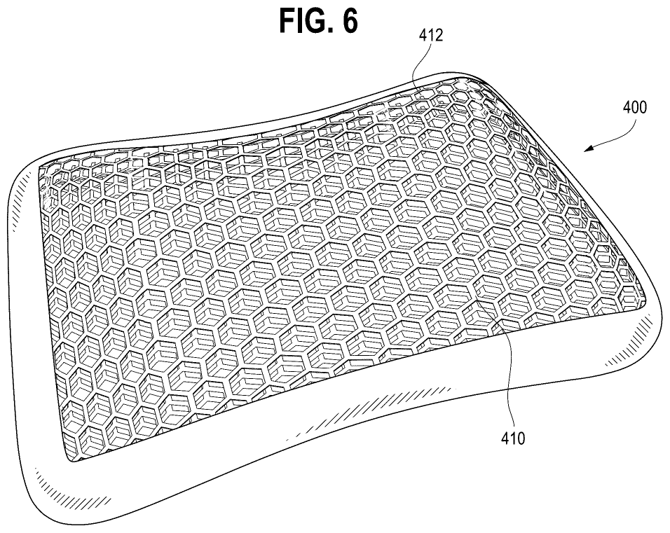

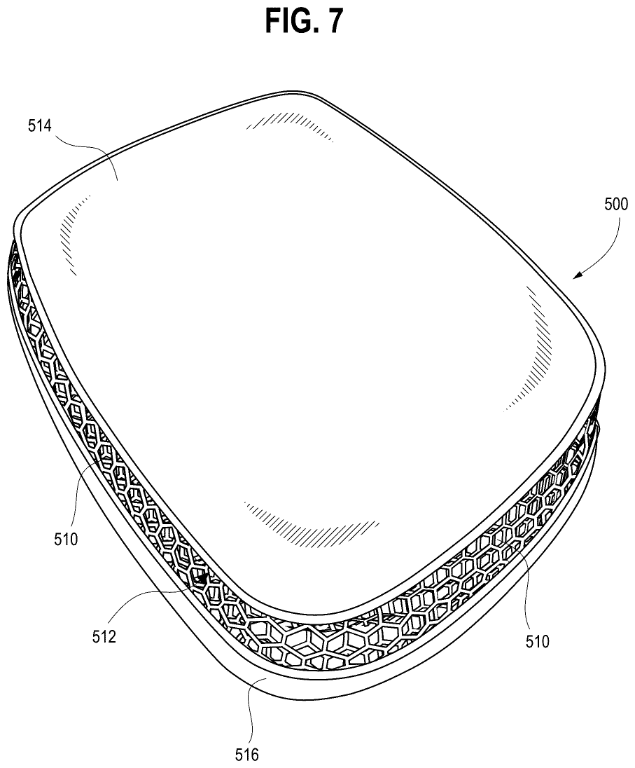

In another aspect, a 3D printed pillow element 410 can be formed and joined to a conventional or other non-3D printed pillow. For example, referring to FIG. 6, a conventional or other non-3D printed pillow 400 can have a 3D printed sheet or layer 410 joined to the top 412 of the conventional or non-3D printed pillow 400. In this manner, a specific or desired area 410 can have varying characteristics while the remainder of the pillow 400 has the characteristics of the conventional or non-3D printed pillow.

In still another aspect, a conventional or non-3D printed pillow 500 can include one or more 3D printed panels 510 in the pillow gusset 512. That is, the 3D printed gusset panels 510 can be joined to conventional top and bottom panels 514, 516 to provide both varying characteristics as well as enhanced air flow through the pillow 500.

The pillows or portions of pillows can be 3D printed using a variety of printing methods such as vat polymerization, stereolithography, digital light processing and the like. Other suitable 3D printing methods will be recognized by those skilled in the art.

It will be appreciated by those skilled in the art that the present 3D printed pillow or pillow having a 3D printed portion (e.g., top) has a number of advantages over known conventional pillows. For example, the softness or firmness characteristics of the pillow can be varied at any area or zone of the pillow. Further, the construction of such a pillow provides for enhanced air flow through the open spaces within the cells to provide a cooling effect. And. depending on the cell construction, enhanced air flow can be provided in one, two or all directions, into and out of the pillow.

The directional references of top, bottom, upper, lower, and side are provided for reference only and are not intended to limit the disclosure in any way.

All patents referred to herein, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

1. A pillow, comprising:
a body have a top, a bottom, and a plurality of sides, wherein at least a portion of the body is formed by a 3 dimensional (3D) printed matrix.

2. The pillow of claim 1, wherein the 3D printed matrix is formed by a plurality of cells, each cell of the plurality of cells having a plurality of struts and nodes interconnecting the struts.

3. The pillow of claim 2, wherein one or more regions of the pillow has a construction characteristic different from a construction characteristic of one or more other regions of the pillow.

4. The pillow of claim 3 wherein one of the one or more regions is a central region.

5. The pillow of claim 4, wherein the central region has a greater softness than the one or more other regions of the pillow.

6. The pillow of claim 5, wherein the one or more other regions surround the central region.

7. The pillow of claim 5, wherein the central region is formed by the 3D matrix having one or more of a lesser density of cells forming the matrix, a lesser volume of material in at least some of the cells, and a different type or shape of the cells that form the central region.

8. The pillow of claim 3 wherein one of the one or more regions is other than a central region.

9. The pillow of claim 8, wherein the other than the central region has a greater softness than a central region of the pillow.

10. The pillow of claim 9, wherein the other than the central region is formed by the 3D matrix having one or more of a lesser density of cells forming the matrix, a lesser volume of material in at least some of the cells, and a different type or shape of the cells that form the central region.

11. The pillow of claim 1, wherein an entirety of the body is formed by the 3D printed matrix.

12. The pillow of claim 1, wherein the top is formed by the 3D matrix.

13. The pillow of claim 1, wherein a portion of the top is formed by the 3D matrix.

14. The pillow of claim 1, wherein the plurality of sides are formed by gusset panels and wherein one or more of the gusset panels are formed by the 3D matrix.

15. The pillow of claim 1, wherein the 3D printed matrix is formed from thermoplastic elastomers (TPEs), thermoplastic polyurethane (TPU), thermoplastic co-polyester (TPC), polyurethane (PU), polyurethane-like and polyurethane-based materials, polypropylene (PP), polyamide (nylon) and combinations thereof.

16. The pillow of claim 1, wherein the pillow is a travel pillows, a continuous positive airway pressure (CPAP) pillow, a cervical pillow, a pregnancy pillow, a chiropractic pillow, or a body pillow.

17. The pillow of claim 16, wherein the pillow has differing support characteristics at different zones of the pillow.

18. The pillow of claim 16, wherein the pillow has a same support characteristics in all of the zones of the pillow.

19. The pillow of claim 1, wherein the body or portion of the body is printed by vat polymerization, stereolithography, digital light processing.
